(19) United States
(12) Patent Application Publication
(10) Pub. No.: US 2006/0091689 A1
(43) Pub. Date: May 4, 2006

(54) Moveable truck toolbox and truck toolbox mounting system for moving a truck toolbox

(76) Inventor: Brian Wilding, Brampton (CA)

Correspondence Address: MILLER THOMPSON, LLP, Scotia Plaza, 40 King Street West, Suite 5800, TORONTO, ON, M5H 3S1, CA

(21) Appl. No.: 11/262,821

(22) Filed: Nov. 1, 2005

(30) Foreign Application Priority Data
Nov. 1, 2004 (CA) 2,486,494

(51) Int. Cl. B60R 9/00

(52) U.S. Cl. 296/37.6

(57) ABSTRACT

A mounting system for mounting a truck toolbox in the rear compartment of a truck is provided that permits movement of the truck toolbox along the length of the side walls of the rear compartment is provided. The mounting system is installed for each of the side walls of the rear compartment. The mounting system includes: a rail disposed on the top of the side wall, a carriage that is connected to the truck tool box and which moves on the rails, and a pair of locking devices that when secured to the rail in abutting engagement of the carriage at either end thereof are operable to block the carriage from being removed from the rail. The blocking engage is achieved by an end portion defined by either end of the carriage overlapping with the locking devices when the locking devices are secured abutting, or in close proximity to, either end of the carriage. A truck toolbox is also provided that incorporates the carriage of the mounting system for mounting on the rail.

### FIELD OF THE INVENTION

This invention relates in general to a moveable truck toolbox that is moveable along the length of the rear compartment on the top of the side walls of a pickup truck box. This invention also relates to a truck toolbox moving system for moving other types of storage containers along the length of the top of the rear compartment side walls of a pickup truck box.

### BACKGROUND OF THE INVENTION

Containers such as toolboxes operable to be stored in the rear compartment of pickup trucks are well-known. For the most part, these toolboxes are operable for use in the bed of a pickup truck. These prior art pickup toolboxes are generally secured to the floor or the lower portions of the side walls of the bed of the pickup truck.

Some prior art pickup toolboxes are known wherein the toolbox is removable from the pickup truck bed. For example, U.S. Pat. No. 4,249,684, issued to Miller et al., discloses a system for providing a removable toolbox. In particular, this patent provides for a system for securing a box to a chassis comprising: a box having a lockable cover, side walls, and a bottom which is raised at least in part; at least two spaced parallel anchor rails affixed to said chassis to which said box may be locked, each of said anchor rails having at least one slot and a configuration which can be accommodated beneath said raised bottom portion of said box, thereby making the anchor rails inaccessible when the box is secured to the chassis; means for securing said anchor rails to said chassis; a pair of brackets, each secured to an interior side wall of said box; at least one locking rod associated with each of said brackets and vertically supported by said brackets, said rods having top and bottom angled portions, said top angled portion overlapping said bracket such that in the locked position only the tip of the angled portion contacts said bracket, said bottom angled portion capable of being inserted into said slot in said anchor rail and rotated underneath said anchor rail such that in the locked position only the tip contacts the anchor rail; a plurality of resilient mounts positioned between the bottom of said box and each of said anchor rails, whereby said resilient mounts assist in maintaining anchoring pressure between said box and said anchor rails and cushion said box against shocks when said box and chassis are transported.

There are numerous disadvantages to the aforesaid prior art pickup toolboxes. First, such prior art toolboxes are generally not moveable. This is disadvantageous because users of such pickup toolboxes often need to remove the toolboxes from the pickup truck to a work site for easy access to the tools contained therein during work, or move the toolbox closer to the door of hatch of the rear compartment. Further, even in the case of prior art pickup toolboxes that are moveable, the mechanism provided for moving same is complicated, expensive to manufacture, and does not adequately address dirt and ice buildup, is difficult to use and takes up a significant amount of space in the pickup bed. In fact, the most significant disadvantage of said prior art pickup toolboxes, whether fixed to the floor of the pickup bed or moveable along the plane of said floor, is that the pickup toolbox resting on the bed and being relatively large takes up a permanent and significant part of the space in the rear compartment. This is a notable disadvantage as the rear compartment is generally used to transport cargo or other stored items, in addition to the pickup toolbox.

Another prior art moveable truck toolbox is described in U.S. Pat. No. 6,464,277 B2, issued to the inventor of this application, Brian Allen Wilding (“Wilding”). In Wilding, a securing system for securing a container to the rear compartment of a truck includes a rail having a protrusion along its length. The protrusion registers with one or more rollers. A securing means secures the container to the securing system. In one particular embodiment, the securing means consists of a hook/brace combination that is operable to secure the container to the rail.

It was found that, in using the Wilding securing system in particular applications, the securing means described might have less than desirable characteristics. The material and manufacturing cost that accompanies the provision of a securing means of this type that is strong enough to secure a heavy metal compartment was found to be relatively significant. Also, in some specific embodiments, the securing means had less than desirable durability and removeability characteristics.

Therefore, there is a need for pickup container such as a toolbox that is moveable and leaves the pickup bed floor substantially free to hold cargo and/or other items. There is also need for a pickup container moving system adaptable to be connected to prior art pickup containers such as toolboxes or other containers suitable for holding bulky articles, the pickup container moving system permitting such containers to be moved within the rear compartment of a pickup or off of said pickup entirely. There is a further need for a mounting system for mounting a toolbox securely onto the side walls of a truck, which mounting system also enables the toolbox to moveable along the length of such side walls, which mounting system is easy to manufacture, inexpensive, and easy to operate.

### SUMMARY OF THE INVENTION

A mounting system for mounting a truck toolbox in the rear compartment of a truck that permits movement of the truck toolbox along the length of the side walls of the rear compartment is provided. The mounting system is installed for each of the side walls of the rear compartment. The mounting system includes: a rail disposed on the top of the side wall, a carriage that is connected to the truck tool box and which moves on the rails, and a pair of locking devices that when secured to the rail in abutting engagement of the carriage at either end thereof are operable to block the carriage from being removed from the rail. The blocking engage is achieved by an end portion defined by either end of the carriage overlapping with the locking devices when the locking devices are secured abutting, or in close proximity to, either end of the carriage.

A truck toolbox is also provided that incorporates the carriage of the mounting system for mounting on the rail.

### BRIEF DESCRIPTION OF THE DRAWINGS

A detailed description of the preferred embodiment(s) is(are) provided herein below by way of example only and with reference to the following drawings, in which:

FIG. 1 is a partial perspective view of a pickup truck showing a first preferred embodiment of the truck toolbox moving system of the present invention;

FIG. 2a is a partial perspective view of one embodiment of the present invention;

FIG. 2b is a partial exploded view of the truck toolbox moving system, illustrating the mounting of the truck toolbox moving system on a side wall of the truck rear compartment, and also a truck toolbox;

FIG. 3a is a side view of the truck toolbox system that illustrates that shows the positioning of the rollers along the length of the sled;

FIG. 3b is a partial side view of the truck toolbox system illustrating the rollers in greater detail;

FIG. 4 is a cross-section of the rail, adjacent to one of the locking devices;

FIG. 5 is a cross-sectional view of the rail and of the sled, adjacent to one of the rollers;

FIG. 6a illustrates an alternate embodiment of the present invention, in which the sled also includes an alignment roller;

FIG. 6b is a cross-sectional view of the rail and the sled, illustrating the particular embodiment illustrated in FIG. 6a;

FIG. 7 illustrates the rear compartment of a truck, with the rails of the present invention mounted on the side walls of the rear compartment, and a cover placed on top of the side walls;

FIG. 8 is a cross-section of the rail, adjacent to one of the rollers, in an alternate embodiment of the rail and the rollers;

FIG. 9 is a cross-section of the rail adjacent to one of the locking devices, in the alternate embodiment of the rail;

FIG. 10 is a partial exploded view of the alternate embodiment of the truck toolbox mounting system, illustrating the mounting of the truck toolbox mounting system on a side wall of the truck rear compartment, and also a truck toolbox; and

FIG. 11 illustrates the tying of the truck toolbox for back up security using a cable.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENTS

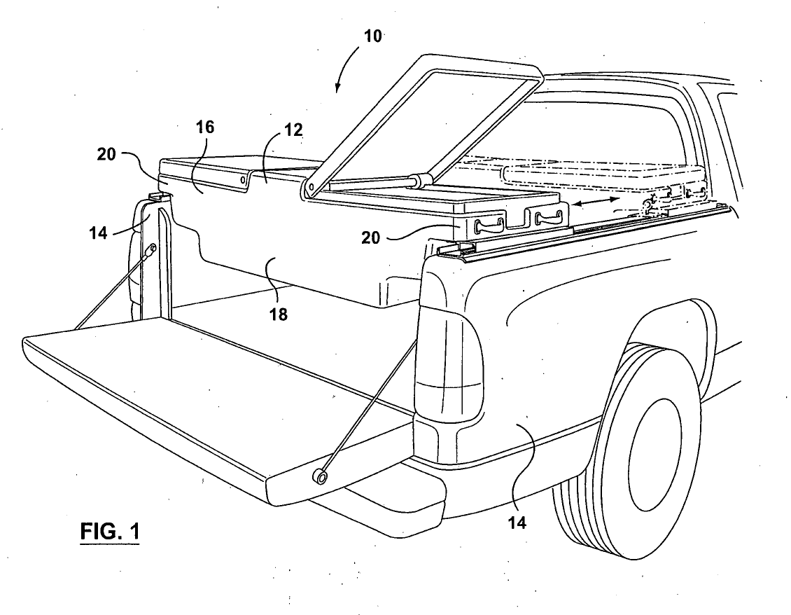

The toolbox mounting system of the present invention is illustrated in FIG. 1, mounted on the rear compartment 10 of a pickup truck. Toolbox 12 is a pickup toolbox of common construction that is generally fastened to the floor of the bed of a pickup truck proximal to the passenger compartment. It should be understood, however, that the system described therein can be used in association with toolboxes of alternate constructions. Further, the moveable truck toolbox described herein can be provided with additional features and other constructions, without departing from the scope of the present invention. Still further toolbox 12 is intended to be representative of other similar compartments intended for use in association with the rear compartment of a pickup truck and also intended for use to store and/or transport bulky items such as camping gear, groceries and the like.

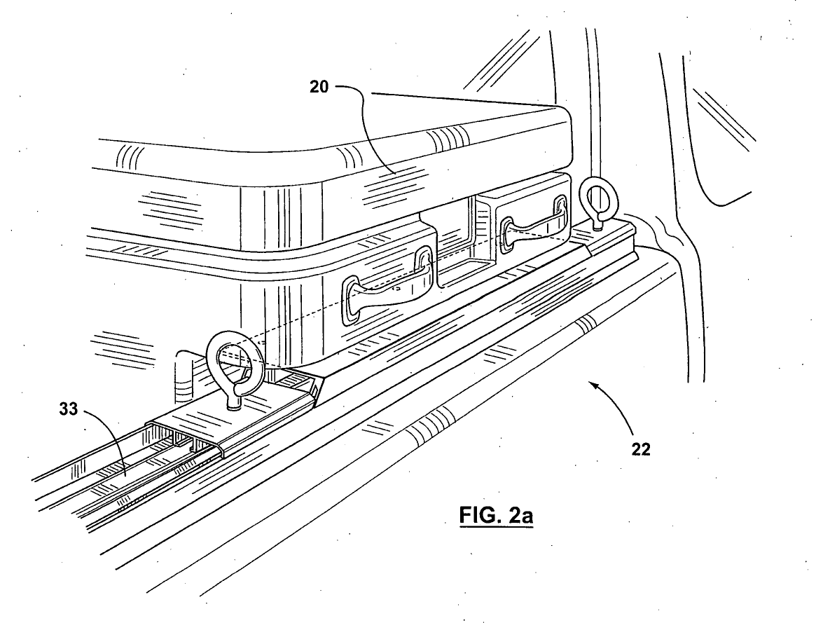

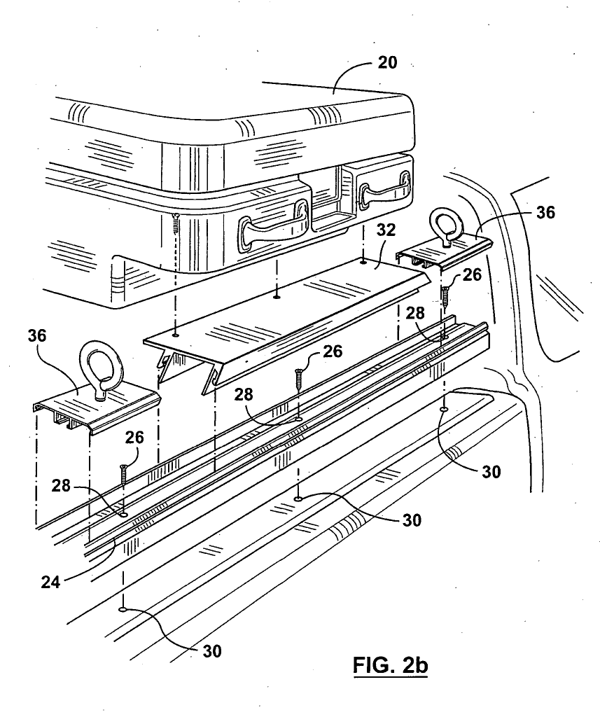

As is the case in most pickup trucks, the rear compartment comprises a pair of side walls 14. Also as illustrated in FIG. 1, said toolbox 12 includes an upper portion 16 which extends laterally beyond a lower portion 18 of said toolbox 12 so as to define side extensions 20 of said upper portion 16. The present invention consists generally of a mounting system 22 that is operable to cooperate with the side extensions 20 so as to mount the toolbox 12 on top of the side walls 14, as shown in FIGS. 1 and 2a.

As illustrated in FIG. 2b, the mounting system includes a rail 24. The rail 24 is fixed on the top of side walls 14, for example, using a plurality of screws 26, which are fastened through apertures 28 in the rail 24 corresponding to a series of apertures 30 provided on the top of the side walls 14. The rail 24 can also be integrated into the rear compartment 10. Other forms of attachment can be used, so long as the rail is solidly attached to the top of the side walls 14.

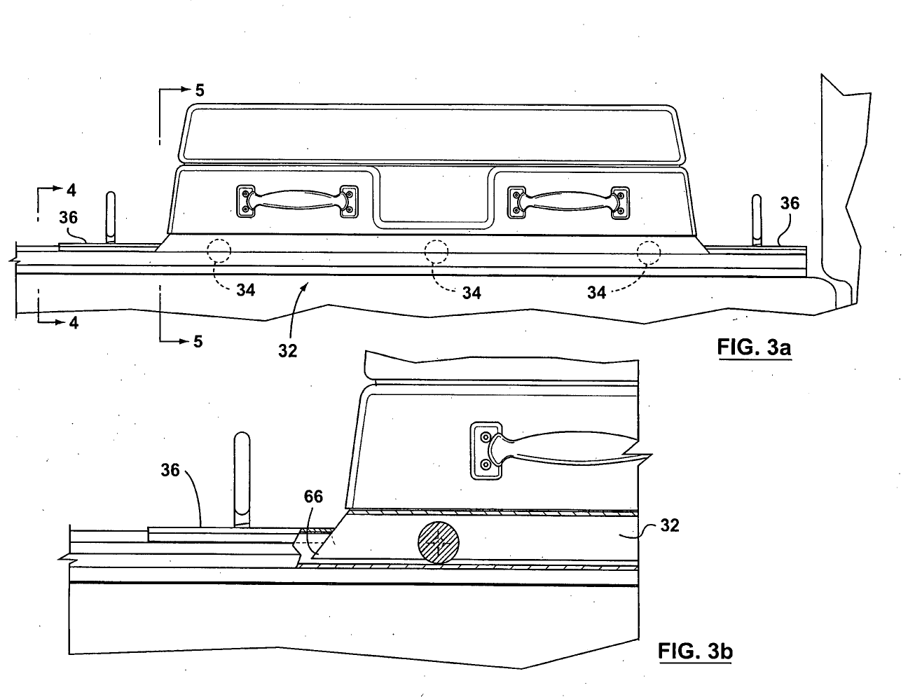

The mounting system of the present invention also-includes a sled or carriage 32. The carriage 32 is preferably fixed to the bottom of the side extensions 20. As shown in FIG. 3a, the carriage extends substantially along the length of the sides of the toolbox 12 adjacent to the side walls 14. Part of the carriage 32 is a series of rollers 34 that, as further particularized below, enable the toolbox 12 to be moved back and forth along the rail 24 by rolling the carriage 32 on rollers 34 disposed on the rail 24, so long as the tie-downs or locking devices 36 do not engage the carriage 32 at either end thereof.

FIG. 5 illustrates a first embodiment of the carriage 32 in which the carriage 32 and the rail 24 each has a cross-sectional profile corresponding to the other. The carriage 32 clicks onto the rail 24 by a user directing manual pressure thereon. The corresponding profile is such that it discourages the removal of the carriage 32 as the carriage 32 and the rail 24 interlock. This particular embodiment of the present invention is also illustrated in FIG. 2b.

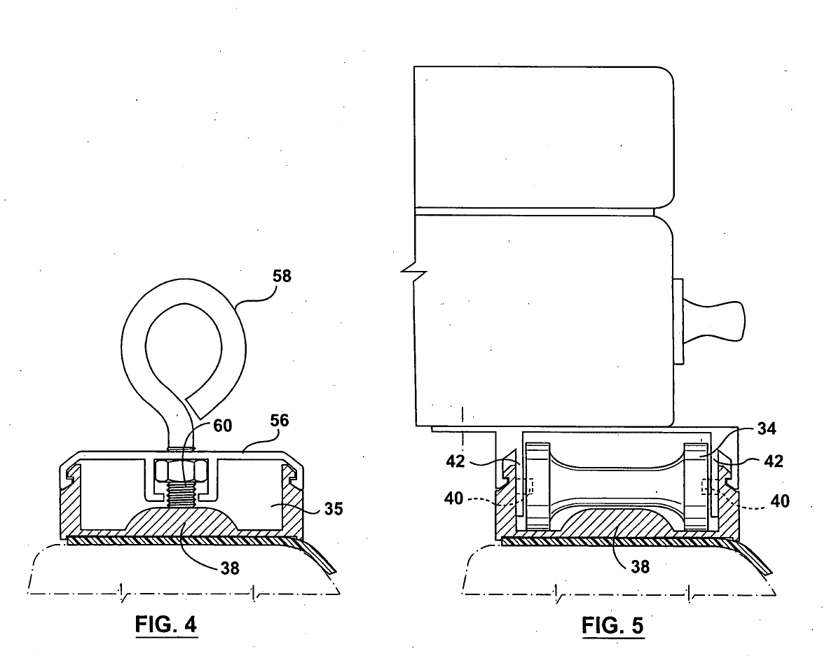

As shown in FIGS. 4 and 5, in the first embodiment of the present invention, the rail 24 includes a protrusion or bump 38 that extends substantially along the length of the rail 24. The rollers 34 are attached to the carriage 32 by means of a pair of axels 40 that are mounted to arms 42 that form part of the carriage 32. It should be understood that once the carriage 32 is fitted onto the rail 24, there is a clearance along the interlocking portions of each of the carriage 32 and the rail 24, such that the carriage 32 can be moved back and forth along the rail 24 by means of the rollers 34 rolling in the passageway 35.

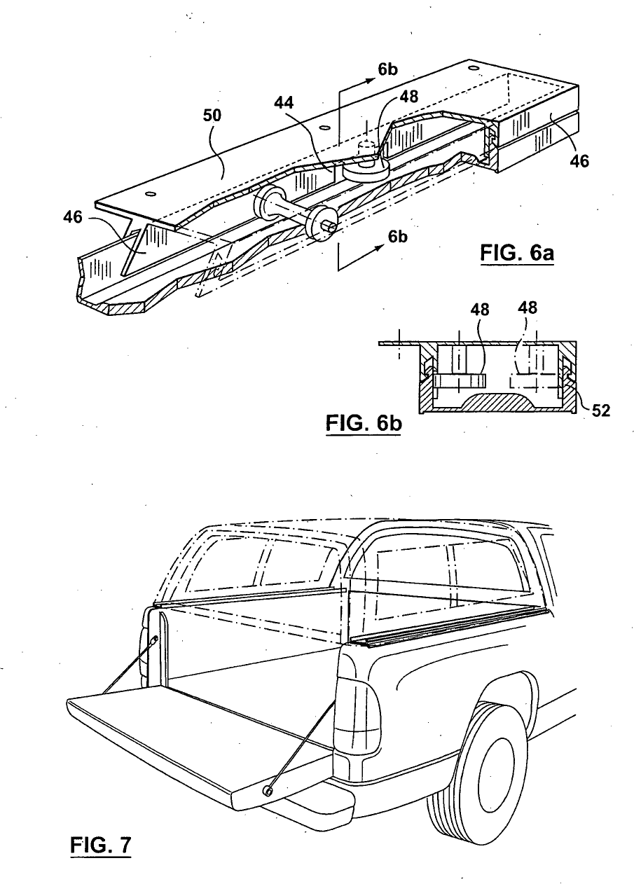

FIGS. 6a and 6b illustrate another feature of the present invention, and in particular a feature of the invention that is useful in relation to the first embodiment of the present invention. A plurality of gaps 44 is disposed in the side walls 46 of the carriage 32, preferably on either side. For illustration purposes, the gaps 44 are shown on one side in FIG. 6a. The carriage 32 also includes a series of alignment rollers 48, which are mounted to the top wall 50 of the carriage in alignment with the gaps 44. In FIG. 6a a particular one of such alignment rollers 48 is illustrated. The function of the alignment rollers 48 is to extend through the gaps 44 and come into contact with the side wall 52 of the rail. When the carriage 32 is moved back and forth along the rail 24, the alignment rollers 48 roll along the side wall 52 of the rail, thereby maintaining the carriage 32 and the rail 24 in alignment, such that the gap between them is maintained. This aids in allowing the carriage 32 to move relative to the rail 24. This particular feature of the invention is further illustrated in FIG. 6b.

FIG. 7 illustrates that when the toolbox 12 is removed, a removable truck top can still be mounted on the rear compartment 10, despite the installation of the rail 24.

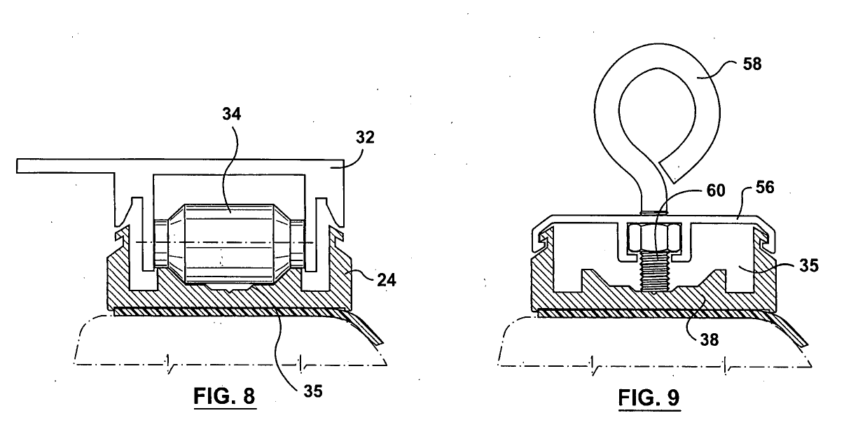

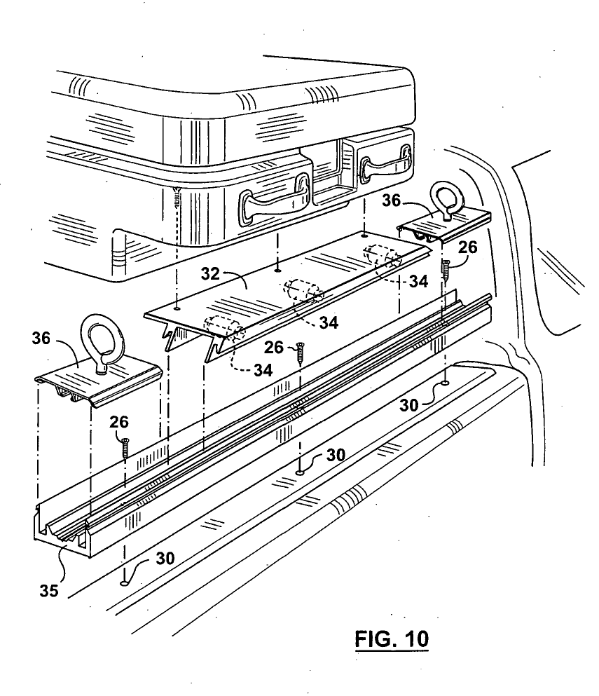

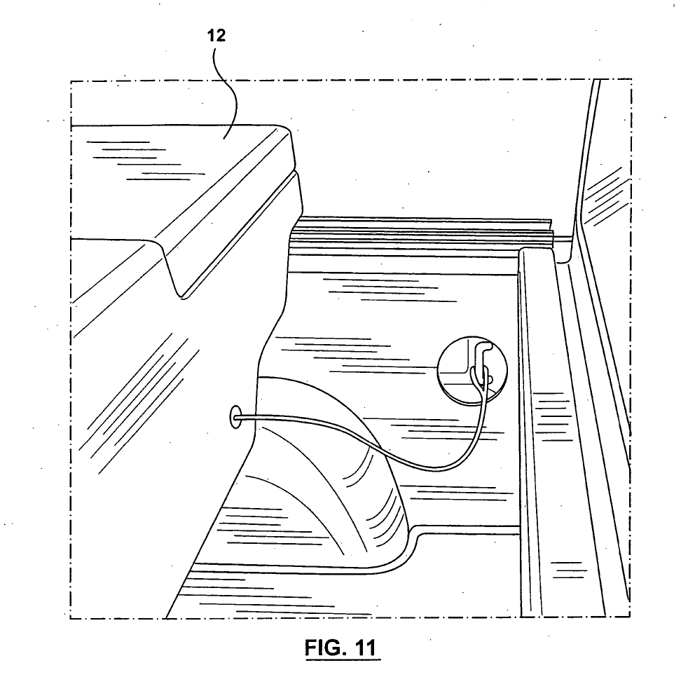

FIGS. 8, 9 and 10 illustrate a second embodiment of the present invention. FIG. 8 illustrates an embodiment of the invention in which the profile of each of the carriage 32 and of the rail 24 is such that the carriage 32 and the rail 24 do not interlock, such that the carriage 32 sits on top of the rail 24, as best illustrated in FIG. 8. Also, the profile the passageway defined by the rail 24, and the corresponding profile of the rollers 34, are also different. This profile is generally horizontal, with slope at either side. The passageway of the rail 24 includes, in addition, a channel 54, disposed generally at the centre of the passageway. The profile of each of the passageway and of the rollers 34 is such that the rollers 34 are self-centring within the passageway. Said profiles also encourage, in part by virtue of the weight of the carriage 32 and of the toolbox 12 mounted on the carriage 32, the rollers 32 to remain in the rail 24. However, it should be understood that in this embodiment of the mounting system 22, the carriage 32 can be lifted out of the rail 24, provided that the locking devices 36 are not engaged.

Extraneous material such as dirt collects in the channel 54 instead of interfering with the movement of the roller 34 within the rail 24. The channel 54 is preferably cleaned to remove any such extraneous materials from time to time, and the design of the rollers will generally effect removal of same.

The design of the locking devices 36 in either embodiment of the invention specifically described herein is the same. As shown in FIGS. 4 and 9, the locking device consists of a plate 56 and a bolt 58. The bolt 58 has a threaded portion 60 that threads through an aperture (not shown) disposed in the plate 56. In one particular embodiment of the bolt 58, it includes a nut 62 and a casing 64 to keep the nut 62 in place. The profile of the plate 56 corresponds to the profile of the rail 24, such that the plate 56 and the rail 24 are interlocking. In addition, the bolt 58 is operable to engage the bottom of the rail 24, thus holding the locking device 36 firmly in place. In a particular embodiment of the invention, the bolt is en eye bolt (as shown in the drawings) so that conveniently the locking devices 36 can be used to tie down cargo.

The locking devices 36 hold the carriage 32 in place by securely mounting the locking devices 36 on the rail 24 (as described above) so as to abut the carriage 32 on either end thereof, thereby bringing the locking devices 36 in blocking engagement of the carriage 32. This blocking engagement occurs because the carriage 32 is provided with an end portion 66, at either end thereof, cut approximately at a 45 degree angle. This end portion overlaps with the locking devices 36, as best shown in FIG. 3b, which prevents the carriage 32 from moving vertically in relation to the rail 24, when the locking devices 36 are locked into place and abutting the carriage 32. Preferably a locking device 36 is brought into such blocking engagement of the carriage 32 at either end thereof.

Other variations and modifications of the invention are possible. For example, side walls 14 of a truck can already be provided with the rails 24 described herein. Also the carriage 32 can already be incorporated into the design of a toolbox 12. It should also be understood that a further benefit of the present invention is that the mounting system 22 described herein can accommodate more than one toolbox 12. If more than one construction worker is travelling to a work site, transportation of more than one toolbox may be required as workers tend to use their own tools. It should be further understood that toolboxes of various types, shapes and sizes can be accommodated by the mounting system disclosed herein, also such alternate toolboxes can be provided with the mounting system described herein. For example, lighter boxes for conveyance of parts and/or construction materials might be used. Such lighter materials might include plastic, fiberglass, wood etc. Also, given the popularity of pick up trucks, boxes for carrying material other than tools are also contemplated by the present invention For example, other boxes may be associated with the moving system described herein, such as boxes for carrying sports equipment (including for example bicycles), camping equipment or groceries, or also, coolers. All such modifications or variations are believed to be within the sphere and scope of the invention as defined by the claims appended hereto.

1. A mounting system for mounting a truck toolbox in the rear compartment of a truck, the rear compartment including a pair of side walls, the mounting system comprising:
(a) a pair of rails disposed on the top of the pair of side walls;
(b) a carriage that is connected to the truck tool box and which is operable to move back and forth on the rails; and
(c) a locking device that when secured to each of the pair of rails in abutting engagement of the carriage preferably at either end thereof is operable to block the carriage from being removed from the rail or from moving back and forth on the rails.
